(19) United States
(12) Patent Application Publication
(10) Pub. No.: US 2004/0104166 A1
(43) Pub. Date: Jun. 3, 2004

(54) Spacer for electrically driven membrane process apparatus

(76) Inventors: David Florian Tessier, Guelph (CA); Ian Glenn Towe, Caledon Village (CA); John H. Barber, Fergus (CA); Guanghui Li, Guelph (CA); Fouad Yacoub, Oakville (CA)

Correspondence Address: ROBERT J. GRAHAM, GOWLING, STRATHY & HENDERSON, SUITE 4900, COMMERCE COURT WEST, TORONTO, ON, M5L 1J3, CA

(21) Appl. No.: 10/331,557

(22) Filed: Dec. 31, 2002

(30) Foreign Application Priority Data
Nov. 29, 2002 (CA) 2,413,467

(51) Int. Cl. B01D 39/08

(52) U.S. Cl. 210/499

(57) ABSTRACT

A spacer mesh is provided and is configured to separate a first ion conducting membrane from a second ion conducting membrane to define a space between the membranes, comprising a plurality of strands consisting essentially of a polymer having a heat distortion temperature of at least 90° C. at 66 psi, and a melt flow index within the range of 3 g/10 min to 6 g/10 min, and being chemically stable at pH>13 or pH<2. The spacer mesh includes a first plurality of spaced apart substantially parallel strand elements, and a second plurality of spaced apart substantially parallel strand elements, wherein the first plurality of strand elements and the second plurality of strand elements are connected to define a netting having a plurality of apertures, each of the apertures having a plurality of vertices defined by a pair of intersecting strands, and a distance between non-adjacent vertices in an aperture is less than 10/1000 of an inch.

### FIELD OF THE INVENTION

The present invention relates to electrically driven membrane process devices and, in particular, to components used to assist in defining flow passages in such devices.

### DESCRIPTION OF THE RELATED ART

Water purification devices of the filter press type which purify water by electrically driven membrane processes, such as electrodyalisis or electrodeionization, comprise individual compartments bounded by opposing ion exchange membranes. Typically, each of the compartments is defined on one side by a membrane disposed to the preferential permeation of dissolved cation species (cation exchange membrane) and on an opposite side by a membrane disposed to the preferential permeation of dissolved anion species (anion exchange membrane).

Water to be purified enters one compartment commonly referred to as a diluting compartment. By passing a current through the device, electrically charged species in the diluting compartment migrate towards and through the ion exchange membranes into adjacent compartments commonly known as concentrating compartments. As a result of these mechanisms, water exiting the diluting compartments is substantially demineralized. Electrically charged species which permeate through the ion exchange membranes and into a concentrating compartment are flushed from the concentrating compartment by a separate aqueous stream flowing through the concentrating compartment.

To this end, the above-described devices comprise alternating diluting and concentrating compartments. In addition, cathode and anode compartments, housing a cathode and an anode respectively therein, are provided at the extreme ends of such devices, thereby providing the necessary current to effect purification of water flowing through the diluting compartments.

For maintaining separation of opposing cation and anion exchange membranes, spacers are provided between the alternating cation and anion exchange membranes of the above-described water purification devices. Therefore, each of the diluting and concentrating compartments of a typical electrically-driven water purification device comprise spacers sandwiched between alternating cation and anion exchange membranes.

Spacers for maintaining separation of opposing ion exchange membranes for defining a concentrating compartment which is not filled with ion exchange resin typically include a mesh structure to support the ion exchange membranes and to assist in preventing the opposing ion exchange membranes from moving closer to one another or, in the extreme, coming into contact with one another. When excessive forces are applied to these ion exchange membranes from within the diluting compartments, the ion exchange membranes have a tendency to move closer to one another, and thereby potentially impede or obstruct flow in the concentrating compartment. Under these conditions, there is an increased risk that the interaction between the membrane and the mesh causes pinhole formation in the membrane. Further, there is a tendency for the membrane to deform into the gaps provided in the mesh. Such deformation of the membrane could compromise sealing engagement between the membrane and the spacer structures it is associated with, thereby creating the potential for leakage between the concentrating and diluting compartments.

### SUMMARY OF THE INVENTION

The present invention provides a spacer mesh configured to separate a first ion conducting membrane from a second ion conducting membrane to define a space between the membranes, comprising a plurality of strands consisting essentially of a polymer having a heat distortion temperature of at least 90° C. at 66 psi, and a melt flow index within the range of 3 g/10 min to 6 g/10 min, and being chemically stable at pH>13 or pH<2.

In one aspect, the polymer is substantially a multicomponent co-polymer having at least two co-monomers wherein at least one of the co-monomers is halogenated. At least one of the co-monomers can be ethylene.

In another aspect, the polymer has a crystallinity of at least 50%.

In yet another aspect, the plurality of strands are configured to define a netting. The plurality of strands can include a first plurality of spaced apart substantially parallel strand elements, and a second plurality of spaced apart substantially parallel strand elements, wherein the first plurality of strand elements and the second plurality of strand elements are connected to provide a netting.

The netting can be non-woven or woven. Further, the netting can be a diagonal netting. The present invention also provides a spacer mesh configured to separate a first ion conducting membrane from a second ion conducting membrane to define a space between the membranes, comprising a plurality of strands consisting essentially of a polymer having a heat distortion temperature of at least 90° C. at 66 psi, and a melt flow index within the range of 3 g/10 min to 6 g/10 min, and being chemically stable when in contact with the first or second ion conducting membranes.

The present invention also provides a spacer mesh configured to separate a first ion conducting membrane from a second ion conducting membrane to define a space between the membranes, comprising a plurality of strands consisting essentially of a halogenated polymer having a melt flow index within the range of 3 g/10 min to 6 g/10 min.

Further, the present invention provides a spacer mesh configured to separate a first ion conducting membrane from a second ion conducting membrane to define a space between the membranes, comprising:

a first plurality of spaced apart substantially parallel strand elements; and

a second plurality of spaced apart substantially parallel strand elements;

wherein the first plurality of strand elements and the second plurality of strand elements are connected to define a netting having a plurality of apertures, each of the apertures having a plurality of vertices defined by a pair of intersecting strands, and a distance between non-adjacent vertices in an aperture is less than

### BRIEF DESCRIPTION OF THE DRAWINGS

The present invention will be better understood with reference to the appended drawings in which:

FIG. 1 is an exploded perspective view of an electrodeionization of the present invention;

FIG. 2 is a schematic illustration of an electrodeionization apparatus of the present invention;

FIG. 3 is a plan view of one side of a C-spacer of the present invention;

FIG. 4 is a sectional elevation view of the C-spacer;

FIG. 5 is an illustration of a sample of mesh of the C-spacer;

FIG. 6 is an illustration of an unclamped mold having mesh interposed between its cavity and core plates for purposes of injection molding;

FIG. 7 is a plan view of the exterior side of the cavity plate of the mold shown in FIG. 6;

FIG. 8 is a plan view of the interior side of the cavity plate of the mold shown in FIG. 6;

FIG. 9 is a plan view of the interior side of the core plate of the mold shown in FIG. 6;

FIG. 10 is an illustration of second unclamped mold having mesh interposed between its cavity and core plates for purposes of injection molding a spacer of the present invention;

FIG. 11 is a plan view of the interior side of the cavity plate of the mold shown in FIG. 10;

FIG. 12 is a plan view of the interior side of the core plate of the mold shown in FIG. 10;

FIG. 13 is a plan view of the exterior side of the cavity plate of the mold shown in FIG. 10;

### DESCRIPTION OF THE PREFERRED EMBODIMENT

Unless otherwise indicated, all numbers expressing quantities of ingredients, properties such as distance, operating conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain errors necessarily resulting from the standard deviation found in their respective testing measurements.

The present invention provides a spacer 50 of a filter press type electrodeionization apparatus 10. An electrodeionization apparatus includes product and waste liquid flow passages defined by opposing flexible ion exchange membranes 28,30. Spacers are provided to maintain spacing between opposing ion exchange membranes 28,30 to facilitate liquid flow between the opposing ion exchange membranes 28, 30.

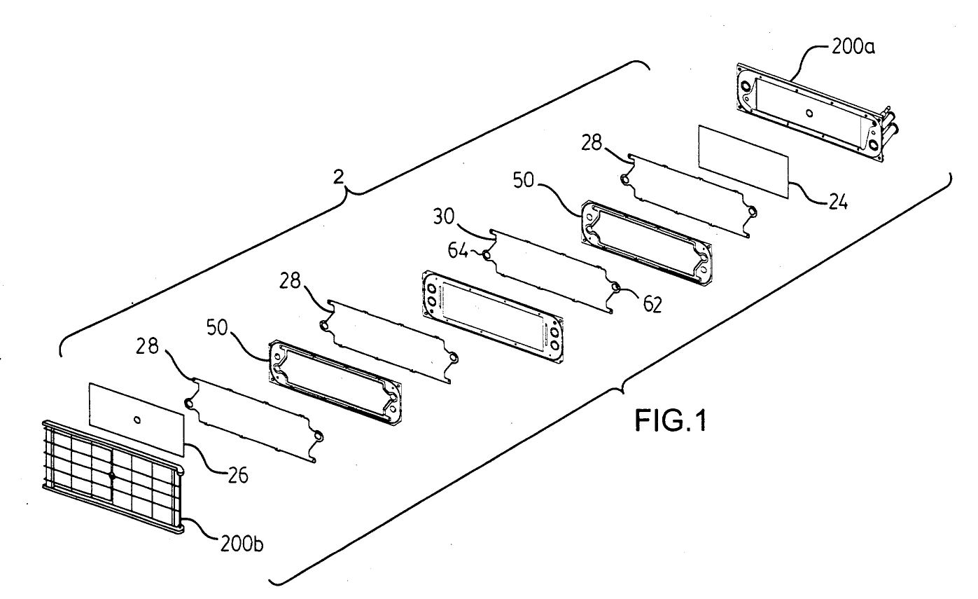

Referring first to FIG. 1, an electrodeionization apparatus 10 in accordance with the present invention comprises an anode compartment 20 provided with an anode 24 and a cathode compartment 22 provided with a cathode 26. A plurality of cation exchange membranes 28 and anion exchange membranes 30 are alternately arranged between the anode compartment 20 and the cathode compartment 22 to form diluting compartments 32 and concentrating compartments 18. A suitable cation exchange membrane 28 is SELEMION CME™. A suitable anion exchange membrane 30 is SELEMION CME™. Both are manufactured by Asahi Glass Co. of Japan. Each of the diluting compartments 32 is defined by anion exchange membrane 30 on the anode side and by a cation exchange membrane 28 on the cathode side. Each of the concentrating compartments 18 is defined by a cation exchange membrane 28 on the anode side and by an anion exchange membrane 30 on the cathode side. Electrolyte solutions are supplied to the anode compartment 20 and to the cathode compartment 22 via flow streams 36 and 38 respectively.

Ion exchange material designated by numeral 40 is provided in diluting compartments 32. Such media enhance water purification by removing unwanted ions by ion exchange. Further, such media facilitate migration of ions towards membranes 28 and 30 for subsequent permeation therethrough, as will be described hereinbelow. The ion exchange material 40 can be in the form of an ion exchange resin, an exchange fibre or a formed product thereof.

Water to be treated is introduced into the diluting compartments 32 from supply stream 50. Similarly, water or an aqueous solution is introduced into the concentrating compartments 18 and into the anode and cathode compartments 20, 22 from a supply stream 44. Pressure of water flowing through the compartments 18, 32 can range from 140 psi to over 200 psi. Water temperature in the concentrating compartment is typically 38° C., but can go as high as 65° C. to 80° C. during thermal sanitation operations. A predetermined electrical voltage is applied between the two electrodes whereby anions in diluting compartments 32 permeate through anion exchange membranes 30 and into concentrating compartments 18 while cations in streams in diluting compartments 32 permeate through cation exchange membranes 28 and into concentrating compartments 18. The above-described migration of anions and cations is further facilitated by the ion exchange material 40 present in diluting compartments 32. In this respect, driven by the applied voltage, cations in diluting compartments 32 migrate through cation exchange resins using ion exchange mechanisms, and eventually pass through cation exchange membranes 28 which are in direct contact with the cation exchange resins. Similarly, anions in diluting compartments 32 migrate through anion exchange resins using ion exchange mechanisms, and eventually pass through anion exchange membranes 30 which are in direct contact with the anion exchange resins. Aqueous solution or water introduced into concentrating compartments 18 from stream 44, and anion and cation species which subsequently migrate into these compartments, are collected and removed as a concentrated solution from discharge stream 48, while a purified water stream is discharged from diluting compartments 32 as discharge stream 42.

To assist in defining the diluting compartments 32 and the concentrating compartments 18, spacers 50,52 are interposed between the alternating cation and anion exchange membranes 28, 30 so as to maintain spacing between opposing cation and anion exchange membranes 28,30 and thereby provide a flowpath for liquid to flow through the compartments 18,32. The anode and cathode compartments 20,22 are provided at terminal ends of the apparatus 10, and are each bound on one side by a spacer 50 and on an opposite side by end plates 200a,200b, respectively. To assemble the apparatus 10, each of the anion exchange membranes 30, cation exchange membranes 28, and associated spacers 50,52 and end plates 200a,200b are forced together to create a substantially fluid tight arrangement.

Different spacers are provided for each of the concentrating and diluting compartments 18, 32. In this respect, the spacer 52 helps define the diluting compartment 32, and is referred to as a “D-spacer”. Similarly, the spacer 50 helps define the concentrating compartment 18, and is referred to as a “C-spacer”.

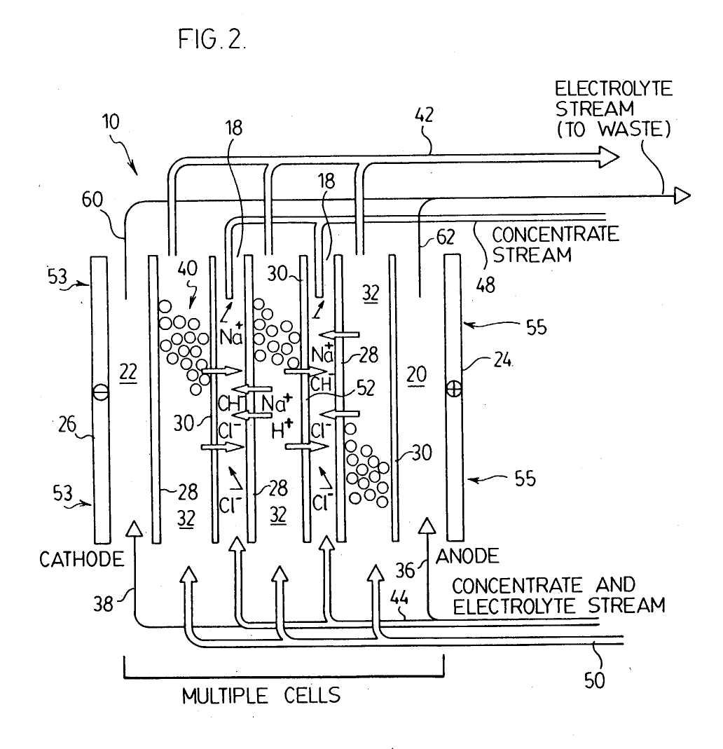

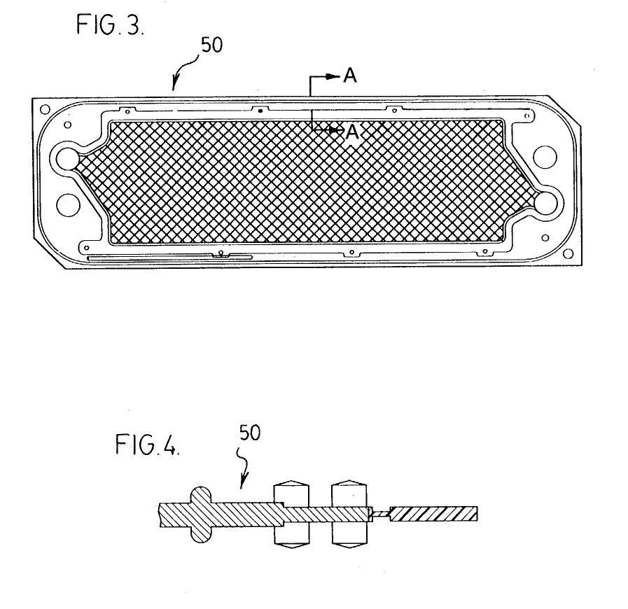

Referring to FIG. 2, the C-spacer 50 comprises a continuous perimeter 54 of thin, substantially flat elastomeric material, having a first side surface 56 and an opposite second side surface 58, and defining a space 60. In this respect, the C-spacer 50 has a picture frame-type configuration. The C-spacer perimeter 54 is comprised of a material which is not prone to significant stress relaxation while able to withstand typical operating conditions in an electrically driven water purification unit with a view to maintaining sealing engagement with adjacent components, such as the membranes 28,30, to mitigate leakage between the compartments 18, 32. In this respect, an example of suitable materials include thermoplastic vulcanizates, thermoplastic elastomeric olefines, and fluoropolymers. The C-spacer 50 can be manufactured by injection moulding or compression moulding.

The first side surface 56 is pressed against an ion exchange membrane, such as a cation exchange membrane 28. Similarly, the opposite second side surface 58 is pressed against a second ion exchange membrane, such as an anion exchange membrane 38. In one embodiment, the ion exchange membrane associated with a side surface of the C-spacer 50 is also pressed against aside surface of the D-spacer 52. In another embodiment, the ion exchange membrane associated with a side surface of the C-spacer 52 is also pressed against a side surface of an electrode end plate 200a,200b, such as a cathode end plate 200b or an anode end plate 200a.

Pressing the cation and anion ion exchange membranes 28,30 against the first and second sides of the C-spacer 10 forms a concentrating compartment 18. The inner peripheral edge 62 of the C-spacer 50 perimeter helps define the space 60 which functions as a fluid passage for aqueous liquid flowing through the concentrating compartment 18.

First and second spaced-apart openings are provided in the concentrating compartment 18 to facilitate flow in and out of the concentrating compartment 18. In one embodiment, first and second throughbores 62,64 can be formed in one or each of the cation and anion ion exchange membranes 28,30 to facilitate flow in and out of the concentrating compartment 18. In this respect, flow is introduced in the concentrating compartment 18 via the first throughbore 62 and is discharged from the concentrating compartment 18 via the second throughbore 64 (flow through the concentrating compartment 18 hereinafter referred to as “C-flow”).

It is understood that other arrangements could also be provided to effect flow in and out of the concentrating compartment 18. For instance, the C-spacer perimeter 54 could be formed with throughbores and channels wherein the channels facilitate fluid communication between the throughbores and the concentrating compartment 18. In this respect, aqueous liquid could be supplied via an inlet throughbore in the C-spacer perimeter 54, flow through a first set of channels formed in the C-spacer perimeter 54 into the concentrating compartment 18, and then leave the concentrating compartment 18 through a second set of channels formed in the C-spacer perimeter 54 which combine to facilitate discharge via an outlet throughbore formed in the C-spacer perimeter 54.

The first and second throughbores 62,64 extend through the surface of the C-spacer perimeter 54. The first throughbore 62 provides a fluid passage for purified water discharging from the diluting compartments 32, the second throughbore 64 provides a fluid passage for water to be purified supplied to the diluting compartments 32 (flow through the diluting compartment 32 hereinafter referred to as “D-flow”). As will be described below, means are provided to isolate C-flow from D-flow.

In one embodiment, throughgoing holes 66,68,70,72 are also provided in the perimeter of the C-spacer 50. Holes 66,68 are adapted to receive alignment rods which assists in aligning the D-spacer 52 when assembly the water purification apparatus. Holes 70,72 are adapted to flow aqueous liquid discharging from the anode and cathode compartments.

The C-spacer 50 further includes a plastic screen or mesh 74 joined to the inner peripheral edge 62 of the perimeter 54 and extending through the space 60 defined by the inner peripheral edge 62 of the perimeter 54. The mesh 74 can be made integral with or encapsulated on the inner peripheral edge 62 of the perimeter 54. The mesh 74 assists in spacing and maintaining a desired spacing between opposing membranes 28,30, which are pressed against the C-spacer 50, by supporting the membranes 28,30 between which the mesh 74 is interposed. In other words, the mesh 74 assists in preventing the opposing membranes 28,30 pressed against the C-spacer 50 from moving closer to one another or, in the extreme, from coming into contact with one another. As opposing membranes 28,30 pressed against the C-spacer 50 move closer to one another or come into contact with one another, flow through the concentrating compartment 18 defined between these opposing membranes 28,30 would be impeded or obstructed. In this respect, the mesh 74 mitigates the creation of such flow impediments or obstructions.

The mesh 74 can be a bi-planar, non-woven high flow mesh. Alternatively, the mesh 74 can be woven.

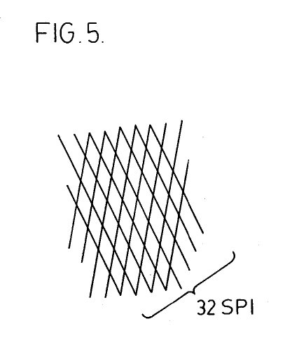

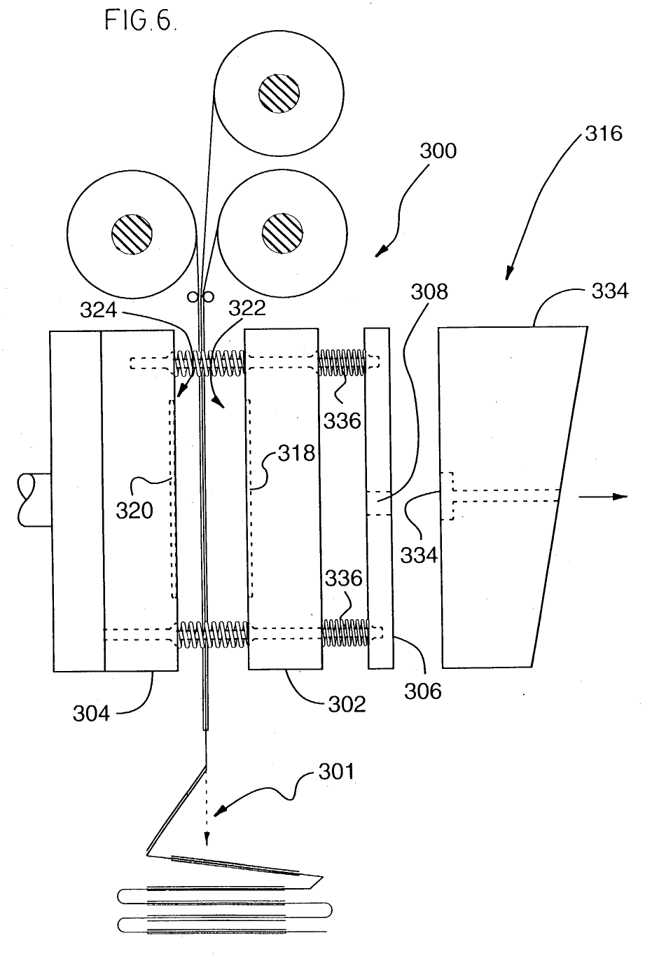

In one embodiment, the mesh 74 consists of a plurality of layers. The layers include at least one inner layer interposed between the outer layers. Each of the two outer layers are adjacent to one of the membranes 28,30. Each layer includes a plurality of strands configured to define a netting. In this respect, the plurality of strands includes a first plurality of spaced apart substantially parallel strand elements and a second plurality of spaced apart substantially parallel strand elements. The first plurality of strand elements and the second plurality of strand elements are connected to provide this netting. The netting can be non-woven or woven. In the embodiment illustrated in FIG. 5, the netting is a diagonal netting (or “diamond-shaped” configuration).

The first plurality of strand elements and the second plurality of strand elements are connected to define the netting having a plurality of apertures. Each of the apertures has a plurality of vertices defined by a pair of intersecting strands. It has been found that the spacing between the strands in each of the outer layers of mesh which are closest to the ion exchange membranes, when the mesh is interposed between the ion exchange membranes, is preferably less than 10/1000 of an inch. In one embodiment, the distance between non-adjacent vertices is less than 10/1000 of an inch. By configuring the mesh 74 in this manner, it has been found that the membranes 28,30, are more effectively supported by the mesh 74 and are less likely to be susceptible to pinhole formation during normal operation of the electrodeionization apparatus 10. As well, by virtue of this design, it is found that the membranes 28,30 are less likely to deform into the apertures of the outer layers of mesh 74 and interfere with flow through the concentrating compartment.

In one embodiment, the mesh 74 consists of three substantially parallel layers, where a single inner layer is interposed between two outer layers. Each of the layers has a bi-planar diagonal or diamond-shaped configuration. The diamond-shape mesh configuration is illustrated in FIG. 5. Each of the outer layers of mesh is characterized by a strand density of 32 strands per inch, wherein each of the strands has a diameter of 20/1000 of an inch. The inner strand layer is characterized by a strand density of 9 strands per inch, wherein each of the strands has a diameter of 40/1000 of an inch. Preferably, the strand density of the outer layers of a mesh 74 having three or more layers is no less than 32 strands per inch.

The mesh 74 comprises a plurality of strands consisting essentially of a polymer having a heat distortion temperature of at least 90° C. at 66 psi, and a melt flow index within the range of 3 g/10 min. to 6 g/10 min. The mesh 74 is chemically stable when in contact with either of the membranes 28,30. Other materials may be present in the composition in amounts not sufficiently significant to detract from the desired properties of the composition, such as mechanical properties, melt processibility, or chemical resistance. Other materials may also be present to enhance these or other properties, in which case the polymer is referred to as being “compounded”. Such materials include slip agents, anti-oxidants, and fillers.

Heat distortion temperature is a measure of a tendency of a material to deflect in response to an applied mechanical force at elevated temperatures. In this context, the heat distortion temperature is measured in accordance with ASTM D648.

Melt flow index is a measure of the degree to which a material is capable of being melt processible. In this context, the melt flow index is measured in accordance with ASTM D1238 (Procedure A).

As explained above, in the electrodeionization apparatus, when assembled, the spacer 50, including the mesh 74, is in contact with ion exchange membranes. Ion exchange membranes include functional groups capable of entering into acid-base reactions. The pH in a typical environment immediately adjacent to anion exchange membrane 30 in an electrodeionization apparatus 10 can approach 13-14. The pH in the typical environment immediately adjacent to the cation exchange membrane 28 in an electrodeionization apparatus 10 during normal operation can be as low as 0-2. Additionally, high pH and low pH cleaning solutions are typically flowed through the concentrating compartments 18 when the electrodeionization apparatus 10 is not operational so as to mitigate biofouling and scaling. The mesh 74 is configured so as to be chemically stable in these pH environments such that electrochemical performance and/or service life of the electrodeionization apparatus 10 is not compromised.

In one embodiment, the polymer is a co-polymer consisting of alternating ethylene co-monomers and chlorotrifluoroethylene co-monomers. An example of a suitable commercially available ethylene chlorotrifluoroethylene co-polymer is HALAR™ manufactured by Ausimont USA. The HALAR polymer is characterized by a heat distortion temperature at 66 psi of 92° C., a melt flow index of 4 g/10 min., and a crystallinity of 50% measured by X-Ray diffraction.

The material comprising the perimeter 54 must be compatible with the material comprising mesh 74 in regard to the manufacture of a unitary component comprising both the perimeter 54 and mesh 74. In this respect, to facilitate melt processing of the C-spacer 50, the perimeter 54 is preferably comprised of material which is melt processible at temperatures which would not cause degradation of the mesh 74. In one embodiment, the material is a thermoplastic elastomer such as a thermoplastic vulcanizate.

In the embodiment illustrated in FIG. 2, discontinuities or gaps 76 maybe provided between the mesh 74 and the perimeter 54 wherein such discontinuities 76 correspond with the first and second throughbores of the cation and anion exchange membranes 28,30. Such discontinuities 76 provide visual assistance in properly aligning the ion exchange membrane in relation to the C-spacer 50 during assembly of the apparatus 10.

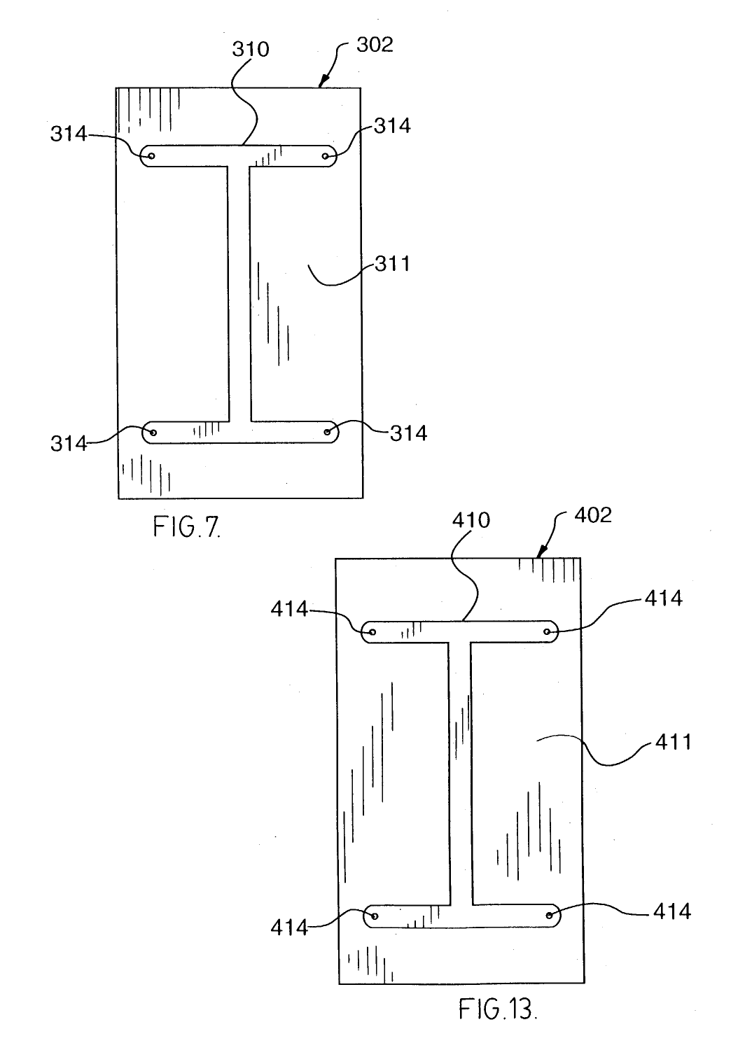

Referring to FIG. 2, the embodiment of the spacer illustrated therein can be manufactured by injection moulding. Where the perimeter 54 is comprised of a high temperature melt processible plastic such as a thermoplastic vulcanizate, the perimeter is preferably overmolded on the mesh by injection molding.

Where the C-spacer 50 is formed by overmolding mesh 74 with perimeter 54, the mesh 74 is first formed and then interposed between cavity plate 302 and core plate 304 of mold 300. This mesh 74 is extruded using a single screw extruder with a counter rotating die. The mesh 74 is extruded as a bi-planar mesh. Referring to FIG. 7, while interposed between plates 302,304, and immediately before the mold 300 is clamped together, mesh 74 is subjected to tensile forces such that the mesh 74 is substantially planar and not slack when the mold 300 is clamped together. In this respect, tension should be provided along the axis indicated by arrow 301. Where such tensile forces are absent, the mesh 74 may become convoluted and remain in this shape when the mold 300 is clamped together. This may result in a C-spacer 50 having a convoluted mesh portion 74, which makes it more difficult for the C-spacer 50 to form effective seals with adjacent structural components.

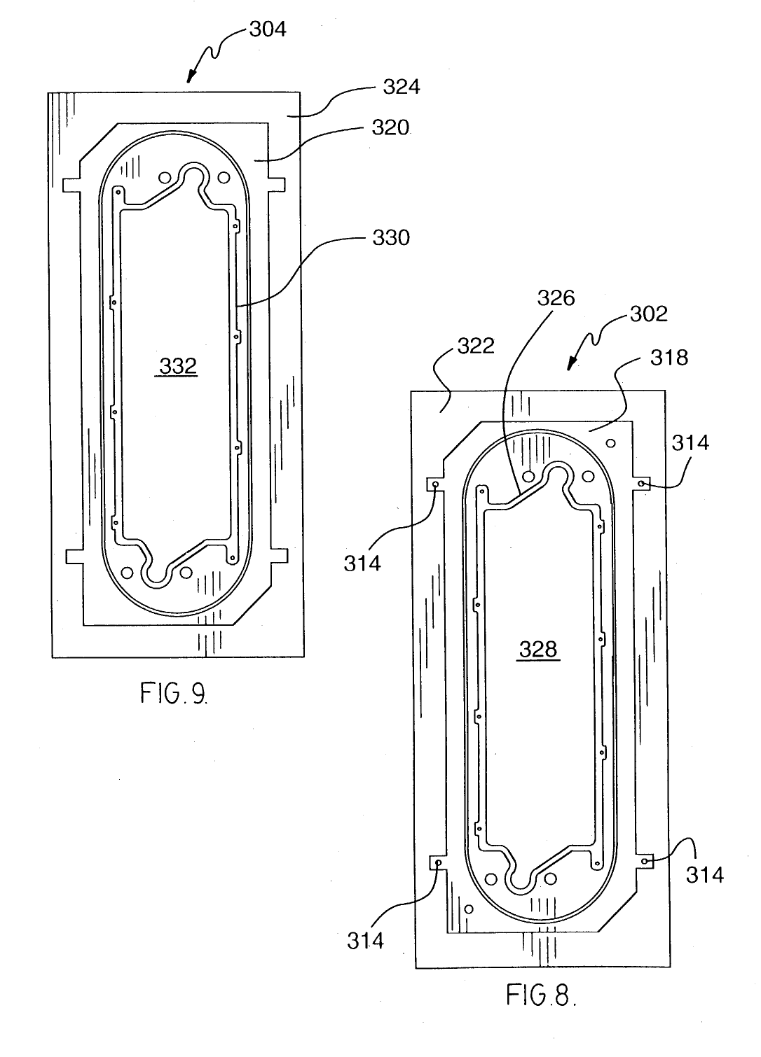

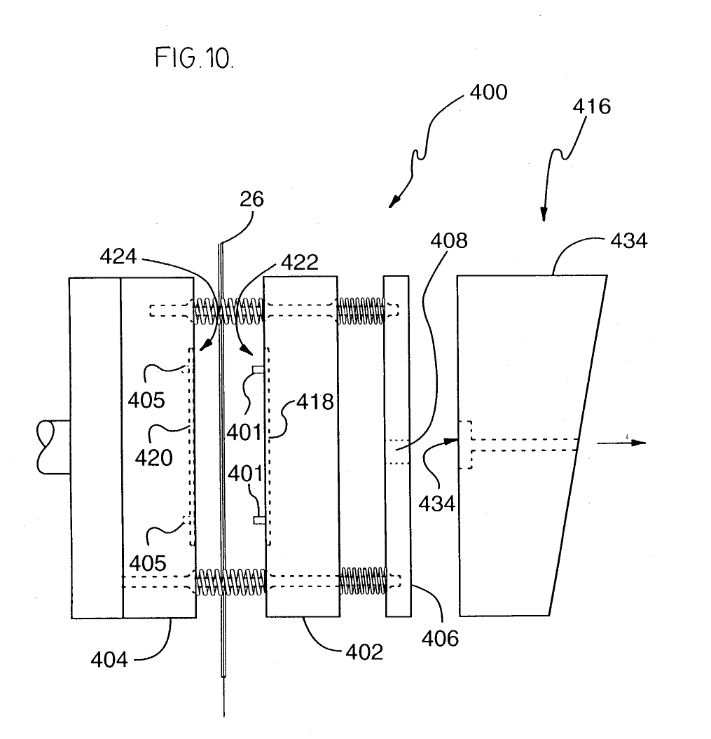

Referring to FIGS. 7,8,9, and 10, in one embodiment, the mold 300 is a three-plate mold comprising a sprue plate 306, a cavity plate 302, and a core plate 304. An injection mold machine 316 is provided to inject feed material through sprue 308 in sprue/runner plate 306. The sprue 308 comprises a throughbore which communicates with a runner system 310 (see FIG. 8) formed as an exterior surface 311 of cavity plate 302. The runners communicate with an interior of cavity 302 through a plurality of gates 314 (see FIG. 9) drilled through cavity plate 302.

When the individual plates 302,304,306 of mold 300 are clamped together, feed material injected by injection mold machine 316 through sprue 308 flows through the runner system 310 and is directed via gates 314 into impressions 318,320. Once inside cavity plate 302, injected feed material fills the impressions 318 and 320 formed in the interior surfaces 322,324 of cavity plate 302 and core plate 304 respectively, such impressions being complementary to the features of C-spacer perimeter 54. In filling the impressions, feed material flows through mesh 26 which is clamped between core and cavity plates 302,304.

To help define inner peripheral edge 62 of C-spacer 50, a continuous ridge 326 depends from interior surface 322 of cavity plate 302 defining a space 328 wherein feed material is prevented from flowing into. Similarly, a complementary continuous ridge 330 depends from interior surface 324 of core plate 304, defining a space 332 wherein feed material is also prevented from flowing into space 328. To this end, when cavity plate 302 and core plate 304 are clamped together, ridges 326 and 330 pinch opposite sides of mesh 26, thereby creating a barrier to flow of injected feed material. In doing so, such arrangement facilitates the creation of inner peripheral edge 62 of C-spacer perimeter 54, to which mesh 74 is joined.

To injection mold the C-spacer embodiment illustrated in FIG. 2, the core and cavity plates 302 and 304 are clamped together, thereby pinching mesh 74 therebetween. Conventional injection mold machines can be used, such as a Sumitomo SH22OA™ injection mold machine. To begin injection molding, material used for manufacturing the C-spacer perimeter 54, such as a thermoplastic vulcanizate, is dropped from an overhead hopper into the barrel of the machine where it is plasticized by the rotating screw. The screw is driven backwards while the material itself remains out in front between the screw and the nozzle. Temperature along the material pathway varies from approximately 193° C. (380° F.) where the material enters the screw to 204° C. (400° F.) immediately upstream of the mold 300.

To begin filling the mold 300, screw rotation is stopped, and molten plastic is thrust forward in the direction of the screw axis through the nozzle 334, sprue 308 and mold gates. Once the mold 300 is filled, injection pressure is maintained to pack out the part. Material shrinkage occurs inside the mold 300 as the temperature is relatively lower than inside the barrel. As a result, pressure must be continuously applied to fill in any residual volume created by shrinkage. When the part is adequately packed and cooled, mold 300 is opened. The ejector pins 336 are actuated, thereby releasing the part.

FIGS. 11,12,13 and 14 illustrate a second mold 400 which could be used to form C-spacer 50 by overmolding mesh 74 with perimeter 54. Mesh 74 is first formed and then interposed between cavity plate 402 and core plate 404 of mold 400. Mesh 74 is extruded using a counter-rotating die in a single screw extruder (having an L/D=24) to produce a bi-planar mesh. The temperature profile from the feed section to the die is 475° F.-485° F.-500° F.-510° F. In particular, mesh 74 is suspended on hanging pins 401 which depend from interior surface 422 of cavity plate 402. To this end, mesh 74 is provided with throughbores which receive hanging pins 401. In one embodiment, mesh 74 is die cut to dimensions such that mesh 74 does not extend appreciably into perimeter 54 once perimeter 54 is formed within impression 418 and 420 by injection molding using mold 400. In this respect, in one embodiment, mesh 74 does not extend across feature on the impressions 418 and 420 which cause the formation of a sealing member or one embodiment of the C-spacer 50. Interior surface 424 of core plate 404 is provided with depressions 405 to receive and accommodate hanging pins 401 when mold 400 is clamped together.

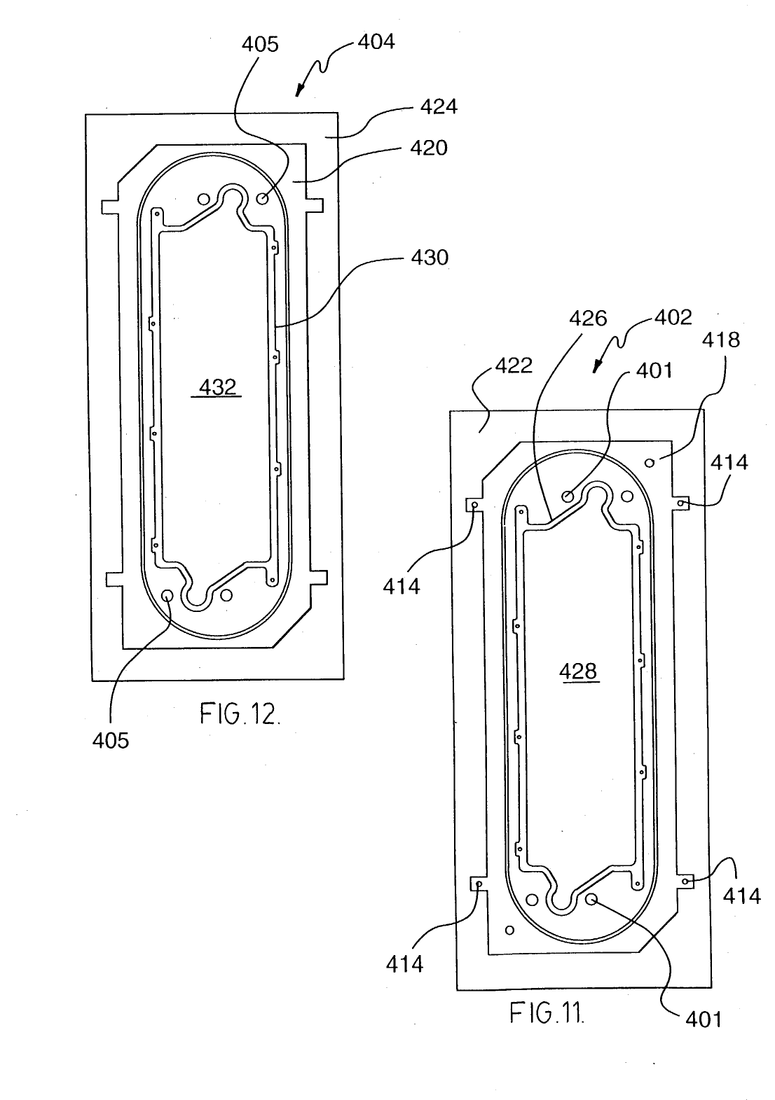

Referring to FIGS. 11,12,13 and 14, in one embodiment, the mold 400 is a three-plate mold comprising a sprue plate 406, a cavity plate 402, and a core plate 404. An injection mold machine 416 is provided to inject feed material through sprue 408 in sprue plate 406. The sprue 408 comprises a throughbore which communicates with a runner system 410 (see FIG. 14) formed as an exterior surface 411 of cavity plate 402. The runners communicate with an interior of cavity 402 through a plurality of gates 414 (see FIG. 12) drilled through cavity plate 402.

When the individual plates 402,404 and 406 of mold 400 are clamped together, feed material injected by injection mold machine 416 through sprue 408 flows through the runner system 410 and is directed via gates 414 into impressions 418 and 420. Once inside cavity plate 402, injected feed material fills the impressions 418 and 420 formed in the interior surfaces 422 and 424 of cavity plate 402 and core plate 404 respectively, such impressions being complementary to the features of C-spacer perimeter 54. In filling the impressions, feed material flows through the perimeter of mesh 74 which is clamped between core and cavity plates 402 and 404.

To help define inner peripheral edge 62 of C-spacer 50, a continuous ridge 426 depends from interior surface 422 of cavity plate 402 to abut a side of mesh 26 defining an interior space 428 wherein feed material is prevented from flowing thereinto. Similarly, a complementary continuous ridge 430 conterminous with continuous ridge 426 depends from interior surface 424 of core plate 404 to abut the opposite side of mesh 74, defining an interior space 432 wherein feed material is also prevented from flowing into space 432. To this end, when cavity plate 402 and core plate 404 are clamped together, opposed conterminous ridges 426 and 430 pinch opposite sides of mesh 74, thereby creating a barrier to flow of injected feed material. In doing so, such arrangement facilitates the creation of inner peripheral edge 62 of C-spacer perimeter 54, to which mesh 74 is joined.

Using mold 400, injection molding of the C-spacer 50 illustrated in FIG. 2 can be accomplished much in the same manner as when using above-described mold 300.

It will be understood, of course, that modification can be made in the embodiments of the invention described herein without departing from the scope and purview of the invention as defined by the appended claims.

1. A spacer mesh configured to separate a first ion conducting membrane from a second ion conducting membrane to define a space between the membranes, comprising a plurality of strands consisting essentially of a polymer having a heat distortion temperature of at least 90° C. at 66 psi, and a melt flow index within the range of 3 g/10 min to 6 g/10 min, and being chemically stable at pH>13 or pH<2.

2. The spacer mesh as claimed in claim 1, wherein the polymer is a multicomponent co-polymer having at least two co-monomers, wherein at least one of the co-monomers is halogenated.

3. The spacer mesh as claimed in claim 2, wherein at least one of the co-monomers is ethylene.

4. The spacer mesh as claimed in any of claims 1, 2, or 3, wherein the polymer has a crystallinity of at least 50%.

5. The spacer mesh as claimed in claim 4, wherein the plurality of strands is configured to define a netting.

6. The spacer mesh as claimed in claim 4, wherein the plurality of strands includes:
a first plurality of spaced apart substantially parallel strand elements; and
a second plurality of spaced apart substantially parallel strand elements;
wherein the first plurality of strand elements and the second plurality of strand elements are connected to provide a netting.

7. The spacer mesh as claimed in claims 5 or 6, wherein the netting is non-woven.

8. The spacer mesh as claimed in claims 5 or 6, wherein the netting is woven.

9. The spacer mesh as claimed in claims 6, 7, or 8, wherein the netting is a diagonal netting.

10. The spacer mesh as claimed in claim 1, wherein the heat distortion temperature is at least 92° C.

11. The spacer mesh claimed in claim 1, wherein the polymer is a co-polymer ethylene and tetrafluoroethylene.

12. A spacer configured to separate a first ion conducting membrane from a second ion conducting membrane to define a space between the membranes, comprising:
a spacer mesh including a plurality of strands consisting essentially of a polymer having a heat distortion temperature of at least 90° C. at 66 psi, and a melt flow index within the range of 3 g/10 min to 6 g/10 min, and being chemically stable at pH>13 or pH<2; and
a perimeter surrounding the spacer mesh, said perimeter comprising a thermoplastic elastomer.

13. The spacer as claimed in claim 12, wherein the perimeter merges with the spacer mesh.

14. The spacer as claimed in claim 13, wherein the polymer is a multicomponent co-polymer having at least two co-monomers, wherein at least one of the co-monomers is halogenated.

15. The spacer as claimed in claim 14, wherein at least one of the co-monomers is ethylene.

16. The spacer as claimed in any of claims 13, 14, or 15, wherein the polymer has a crystallinity of at least 50%.

17. The spacer as claimed in claim 16, wherein the plurality of strands is configured to define a netting.

18. The spacer as claimed in claim 16, wherein the plurality of strands includes:
a first plurality of spaced apart substantially parallel strand elements; and
a second plurality of spaced apart substantially parallel strand elements;
wherein the first plurality of strand elements and the second plurality of strand elements are connected to provide a netting.

19. The spacer as claimed in claims 17 or 18, wherein the netting is non-woven.

20. The spacer as claimed in claims 17 or 18, wherein the netting is woven.

21. The spacer as claimed in claims 18, 19, or 20, wherein the netting is a diagonal netting.

22. The spacer as claimed in claim 12, wherein the heat distortion temperature is at least 92° C.

23. The spacer as claimed in claim 12, wherein the polymer is a co-polymer of ethylene and tetrafluoroethylene.

24. A spacer mesh configured to separate a first ion conducting membrane from a second ion conducting membrane to define a space between the membranes, comprising a plurality of strands consisting essentially of a polymer having a heat distortion temperature of at least 90° C. at 66 psi, and a melt flow index within the range of 3 g/10 min to 6 g/10 min, and being chemically stable when in contact with the first or second ion conducting membranes.

25. A spacer mesh configured to separate a first ion conducting membrane from a second ion conducting membrane to define a space between the membranes, comprising a plurality of strands consisting essentially of a halogenated polymer having a melt flow index within the range of 3 g/10 min to 6 g/10 min.

26. A spacer mesh configured to separate a first ion conducting membrane from a second ion conducting membrane to define a space between the membranes, comprising:
a first plurality of spaced apart substantially parallel strand elements; and
a second plurality of spaced apart substantially parallel strand elements;
wherein the first plurality of strand elements and the second plurality of strand elements are connected to define a netting having a plurality of apertures, each of the apertures having a plurality of vertices defined by a pair of intersecting strands, and a distance between non-adjacent vertices in an aperture is less than 10/1000 of an inch.
